(19) United States
(12) Patent Application Publication
(10) Pub. No.: US 2020/0184440 A1
(43) Pub. Date: Jun. 11, 2020

(54) DISTRIBUTED POINT OF SALE SERVER SYSTEM

(71) Applicants: Jason Pennington, (US); Justin Pennington, (US)

(72) Inventors: Jason Pennington, Miamisburg, OH (US); Justin Pennington, Hillsborough, NC (US)

(21) Appl. No.: 16/214,129

(22) Filed: Dec. 9, 2018

(51) Int. Cl. G06Q 20/20

(52) U.S. Cl. CPC G06Q 20/202; G06Q 20/204; G06Q 20/207; G06Q 20/203

(57) ABSTRACT

The system of the present invention comprises of a plurality of Point of Sale (POS) system deployed at the different location wherein the Point of Sale (POS) system communicates with a public server (for example cloud-based architecture). The system facilitates the data communication and synchronization among the plurality of the Point of Sale (POS) system via the public server wherein the one of the plurality of Point of Sale (POS) system is a Local Point of Sale (POS) system that coordinates the data from the plurality of Point of Sale (POS) system during low network connectivity (offline mode) and stores the data in its local memory and transfer the data to the public server when the network connectivity is regained (online mode). The Local Point of Sale (POS) system is a single board computer connected through local area network.

### FIELD OF THE INVENTION

The present invention generally relates to client-server Point of Sale (POS) systems. More specifically, the invention relates to the system for synchronization of Point of Sale (POS) data in both the online and offline environment.

### BACKGROUND OF THE INVENTION

Point of Sale (POS) systems are quite popular today. Point of Sale (POS) system allows the merchants to process the purchases made by the customers at the point of sale. The POS system records the items purchased by the customer in order to calculate the transaction and presents a receipt of goods purchased to the customer and receives the payment from the customer.

Traditional Point of Sale (POS) systems stores the data on local servers or and runs on a closed internal network. Nowadays the Point of Sale (POS) systems stores the data on a central server accessible to all local Point of Sale (POS) systems distributed geographically. The central server allows the synchronization of the data among all the local Point of Sale (POS) systems. However, this approach needs a continuous internet connection.

Moreover, every enterprise and/or retail needs a high performing and reliable Point of Sale (POS) systems that can operate quickly with or without a network connection to the enterprise main system. Therefore, there exists a need for a system that allows for a Point of Sale (POS) systems to be centrally managed and operate offline.

### BRIEF SUMMARY OF THE INVENTION

The system of the present invention comprises of a plurality of Point of Sale (POS) system deployed at the different location wherein the Point of Sale (POS) system communicates with a public server (for example cloud-based architecture). The system facilitates the data communication and synchronization among the plurality of the Point of Sale (POS) system via the public server wherein the one of the plurality of Point of Sale (POS) system is a local Point of Sale (POS) system that coordinates the data from the plurality of Point of Sale (POS) system during low network connectivity (offline mode) and stores the data in its local memory and transfer the data to the public server when the network connectivity is regained (online mode). The Local Point of Sale (POS) system is a single board computer connected through local area network.

According to one aspect of the system of the present invention, the data is entered into the public server and/or the local Point of Sale (POS) system through a user interface. The user of the system is enabled to access the data via the public server. In case of low network connectivity, the user is enabled to access the data via the local Point of Sale (POS) system wherein the local Point of Sale (POS) system stores a copy of up to date data from the plurality of Point of Sale (POS) system.

According to another aspect of the present invention the public server is operative to receive the data from the local Point of Sale (POS) system. By example and without limitation, the local Point of Sale (POS) system is enabled to receive data from the public server and stores it in the local memory of local Point of Sale (POS) system and propagate the data to the plurality of Point of Sale (POS) systems.

According to another aspect of the present invention, the system herein, the data from all the plurality of Point of Sale (POS) system is propagated and replicated into the local Point of Sale (POS) system. The system enables the plurality of Point of Sale (POS) system to work in offline mode.

### BRIEF DESCRIPTION OF THE DRAWING

The foregoing and other objects, aspects and advantages are better understood from the following detailed description of a preferred embodiment of the invention with reference to the drawings, in which:

FIG. 1 is a flow chart illustrating the working of the system of the present invention.

### DETAIL DESCRIPTION OF THE INVENTION

The present method will be more completely understood through the following detailed description which should be read in conjunction with the attached drawing in which similar reference numbers indicate similar structures. All references cited above and in the following description are hereby expressly incorporated by reference.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

The present invention relates to the system for the synchronization of Point of Sale (POS) system data in both online and offline network connection. The system of the present invention comprises of a plurality of Point of Sale (POS) system deployed at the different location wherein the Point of Sale (POS) system communicates with a public server (for example cloud-based architecture). The system facilitates the data communication among the plurality of the Point of Sale (POS) system wherein the one of the plurality of Point of Sale (POS) system is a Local Point of Sale (POS) system that coordinates the data from the plurality of Point of Sale (POS) system and stores the data in its local memory and transfer the data to the public server when the network connectivity is regained.

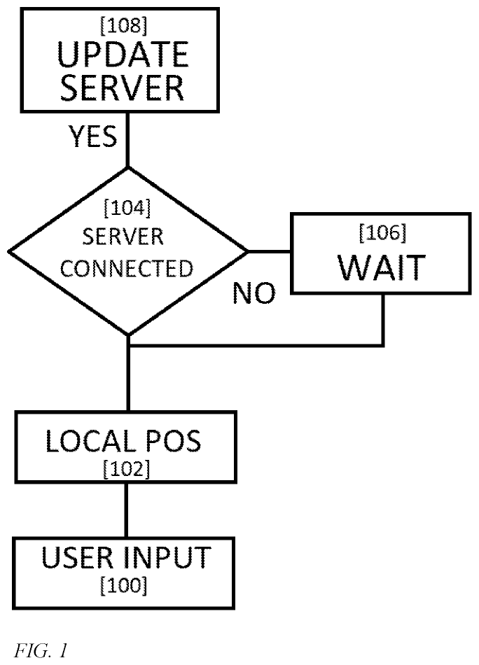

FIG. 1 is a flowchart illustrating the working of the system in accordance with the preferred embodiment of the present invention. At Step (100), a user enters data relating to a transaction wherein the transaction data is relating to purchase of goods and/or services at the retail location by a customer. At Step (102), the Point of Sale (POS) system saves that data and sends the query to the public server for authentication. At Step (104), the system checks the availability of a network connection (i.e. online) and if the network connection is available, At Step (108), the connection is established and the transaction data is sent to the public server. The public server processes the received transaction data and sends the data to the Point of Sale (POS) system and update all the other Point of Sale (POS) system with the data for synchronization of data among the plurality of the Point of Sale (POS) system. Further, At Step (106), the local Point of Sale (POS) system server will periodically check for a connection to the public server, if the network connection is not available. The local server will transfer the data to the public server at the availability of network connection.

According to one aspect of the system of the present invention, the data is entered into the public server and/or the local Point of Sale (POS) system through a user interface. The user of the system is enabled to access the data via the public server. In case of low network connectivity, the user is enabled to access the data via the local Point of Sale (POS) system wherein the local Point of Sale (POS) system stores a copy of up to date data from the plurality of Point of Sale (POS) system.

According to another aspect of the present invention the public server is operative to receive the data from the local Point of Sale (POS) system. By example and without limitation, the local Point of Sale (POS) system is enabled to receive data from the public server and stores it in the local memory of local Point of Sale (POS) system and propagate the data to the plurality of Point of Sale (POS) systems.

According to one exemplary embodiment of the present invention, when a clerk at retail store enters a data on a Point of Sale (POS) system, the Point of Sale (POS) system transfers the data to the public server and the data is shared with all other Point of Sale (POS) system on a Point of Sale (POS) network connected with the public server. The Point of Sale (POS) system may be at least one of the but not limited to desktop computers, tablet computers, smartphones, cash registers. Further, the Point of Sale (POS) system may also include a web dashboard. The web dashboard provides an interface for a merchant to manage the services provided by the system.

According to another exemplary embodiment of the present invention the plurality of Point of Sale (POS) system are enabled to handle tolerance of network failure and/or server unavailability. The plurality of Point of Sale (POS) system is enabled to work completely offline and may synchronize with one or more public server (i.e. cloud server). The system of the present invention facilitates synchronization of the data (for example, inventory items, menus, orders, reports, etc.) between all the Point of Sale (POS) system associated with one or more merchant account. Further, the Point of Sale (POS) system provides encryption of credit card, debit card data details.

According to another exemplary embodiment of the present invention the synchronization of the data among the plurality of the Point of Sale (POS) systems ensures that all the POS system have the data they need to work in the offline mode and any other data that has been changed by one merchant and/or sales clerk of retail store is synchronized when the POS system came back online. The data may be at least one of the but not limited to inventory item names, price, UPC code, sales data, tax data, customer records, employee's data etc.

According to another exemplary embodiment of the present invention each Point of Sale (POS) system is connected to the local area network where any end terminal can access the data in the POS system. When the data is entered into the end terminals, the local POS system is updated with new data. Further, when the data in the local POS system is updated, the local POS system updates the public server wherein the public server updates all the other Point of Sale (POS) system for synchronization of the data.

According to another exemplary embodiment of the present invention, the local POS system may be a Single Board Computer (SBC). The SBC is added to the current local area network and the existing computers can access the data on the SBC via the user interface. The data on the SBC is accessed when data from the public server is not accessible. Further, the user interface served from the POS is generated by dynamic HTML web pages with a database layer to store data from the end terminals. The data consists of part numbers, invoices, and expense numbers associated with the inventory items sold.

According to another exemplary embodiment of the present invention, the Point of Sale (POS) system is enabled to generate reports for inventory, tax, sales, customer records, and expenses. The reports generated are sent to the public server during the availability of network connection (i.e. online mode). The other Point of Sale (POS) system is enabled to access the reports from the public server in real-time. The sales information is linked with the customer even if the customer patrons another location with the POS system.

According to another exemplary embodiment of the present invention, the plurality of Point of Sale (POS) system can also track a lengthy return process that involves multiple vendors and/or merchant. The return process is the process where the product is returned from the customer consists of subcomponents each of which offered by the different merchants. To complete a return where the customer agrees to wait for the subcomponents to be returned, the Point of Sale (POS) system tracks the subcomponents to ensure proper credit is received.

According to another exemplary embodiment of the present invention, the POS system can process invoices with one or more payment methods at retail locations. The POS system can process credit cards and debit cards. Invoices can also be marked as unpaid where payments could be issued in installments and with multiple payment methods. The POS system can also generate a report with unpaid reports alerting the user of all unpaid invoices across all the other Point of Sale (POS) system.

Having now described a few embodiments of the present computer-implemented process, it should be apparent to those skilled in the art that the foregoing is merely illustrative and not limiting, having been presented by way of example only. Numerous modifications and other embodiments are within the scope of one of ordinary skill in the art and are contemplated as falling within the scope of the present process as defined by the appended claims and equivalent thereto.

1. A distributed POS system comprising: network connectivity, public server, local POS systems, and data to be shared. Data is entered into local POS systems which updates the public server and all local systems.

2. The local POS system of claim 1 further comprising: a local area network connection, redundant server, and end terminals. Said data is entered into the end terminals which updates the public server.

3. The local POS system of claim 2 wherein said redundant server is a single board computer connected to said local area network connection.

4. The local POS system of claim 2 wherein the end terminals access the user interface of said public server for data retrieval. Data is served from the said redundant server over local area network if said network connectivity is lost.

5. The local POS system of claim 4 wherein the said public server generates dynamic HTML webpages.

6. The local POS system of claim 5 wherein the said webpages store data in a database layer.

7. The local POS system of claim 4 wherein the said redundant server generates dynamic HTML webpages.

8. The local POS system of claim 7 wherein the said webpages store data in a database layer.

9. The local POS system of claims 6 and 8 wherein the data can consist of part numbers, invoices, and expense numbers.

10. The local POS system of claim 9 wherein the said part numbers stored in the said database layer are used to generate inventory lists.

11. The local POS system of claim 9 wherein the said invoices stored in said database layer are used for tax reports.

12. The local POS system of claim 9 wherein the said redundant server generates real-time detailed sales and performance reports from said invoices and makes the said reports available through the said public server.

13. The distributed POS system of claim 1 wherein inventory stocking levels are shared in real-time to other said local POS systems.

14. The local POS system of claim 9 wherein product returns, deposits, and cores are tracked through each step of the return process in said database layer.

15. The local POS system of claim 9 wherein new customer records are linked to all orders placed by that customer.

16. The local POS system of claim 9 wherein statements can be generated for all orders placed but are unpaid.

17. The local POS system of claim 9 wherein orders can be marked paid by one or more payment methods.
